(19) United States
(12) Patent Application Publication
(10) Pub. No.: US 2006/0192784 A1
(43) Pub. Date: Aug. 31, 2006

(54) Image reproduction apparatus and program, and photo movie producing apparatus and program

(75) Inventors: Kei Yamaji, Kanagawa (JP); Hajime Araya, Kanagawa (JP); Takayuki Iida, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/362,945

(22) Filed: Feb. 28, 2006

(30) Foreign Application Priority Data
Feb. 28, 2005 (JP) 2005-054369

(51) Int. Cl. G06T 15/70; G06T 13/00

(52) U.S. Cl. 345/473

(57) ABSTRACT

When a slide show in which a plurality of still images is reproduced and displayed in sequence is executed, the number of subjects captured in each still image is determined. Display time of each still image is calculated based on the determined number of the subjects. The number of the subjects is determined from the number of faces detected in the still image. The faces smaller in size than a predetermined value are eliminated from the number of the subjects. The display time is obtained by multiplying the number of the subjects by a predetermined coefficient. When the number of the subjects is larger than a criterion subject number M, the coefficient is set small. Accordingly, it is prevented that the display time is set unduly long.

### BACKGROUND OF THE INVENTION

1. Field of the Invention

The present invention relates to an apparatus and a program for reproducing still images of people as subjects, and to an apparatus and a program for producing a photo movie from still images of people as subjects.

2. Description of the Related Arts

A still image captured by a digital still camera is normally enjoyed by printing on a photographic paper, and further enjoyed by loading image data into a personal computer (PC) to display it on a monitor by using an image viewer software. In many cases, an image viewer software is provided with a slide show function, which displays still images by changing over the images at a predetermined time interval. By using such function, a user can easily enjoy a large number of still images. Recently, digital still cameras, which capture images and immediately display a slide show of the captured images, are on the market.

In conventional image viewer software, display time assigned for each still image is even when a number of still images are reproduced as a slide show by automatically changing over the still images. For this configuration, the display time for a still image of a relatively monotonous scenic shot showing only a broad sky and a lake, which would be worth only a glance, and the display time for a still image of a relatively dynamic shot showing a forest and a river, which requires time to view in detail, become same. Therefore, the dynamic shots cannot be viewed in sufficient time when the display time is set for the monotonous shots. On the other hand, the monotonous shots become redundant when the display time is set for the dynamic shots. The Japanese patent laid-open publication No. 2004-320379 discloses an image reproduction apparatus, which assigns different display time to each still image in accordance with its content analyzed on the resolution and contrast.

The Japanese patent laid-open publication No. 10-200843 and “Imaginate 2.0” from Canopus Co., Ltd, searched on Nov. 1, 2004, via the Internet, <URL:http://www.canopus.co.jp/catalog/imaginate/imaginate20_index.htm> disclose a photo movie, which is regarded as another way of enjoying still images easily. In the disclosed photo movie, still images are combined with special effects and reproduced as a moving image. The special effects include a zoom-in processing, which closes up a part of the still image, a panning processing, which moves an eyepoint from one end of the still image to the other, and other processing. In the photo movie, one frame of a moving image is created from a cut-off part of a still image or a converted still image to have a skew effect, thereby emphasizing a specific subject or adding realism to the still image. Such photo movie attracts attention as a new form of storage of the still images.

The minimum unit of a photo movie is a scene, which specifies a still image to be used, type of special effect, and display time. When a plurality of still images is used, a plurality of scenes is combined together to constitute the photo movie. In contrast to the slide show, display time of each scene can be set by a user in the photo movie, therefore it is possible to adjust the display time of the scenes with important still images to be longer than that of the other scenes.

For this configuration, for instance, still images worth only a glance, such as a portrait and still images, which require more time to view, such as a group shot can be treated differently and thus proper display time can be assigned to each still image. However it is very cumbersome for the user to assign the display time to each still image with checking its content, especially when there are many still images.

### SUMMARY OF THE INVENTION

In view of the foregoing, an object of the present invention is to provide an image reproduction apparatus and program capable of setting appropriate display time of still images based on the contents of the still images, and a photo movie producing apparatus and program capable of setting appropriate display time of a photo movie based on the contents of the still images.

To achieve the above and other objects, an image reproduction apparatus of the present invention includes a subject number determining device and a display time setting device. The subject number determining device detects people as subjects in each still image to determine the number of the subjects. The display time setting device sets display time of each still image based on the number of the subjects determined by the subject number determining device.

The subject number determining device detects faces of the subjects and determines the number of the subjects based on the number of detected faces. Moreover, the subject number determining device determines whether each of the faces is larger in size than a predetermined value. The subject number determining device eliminates the faces smaller in size than the predetermined value to determine the number of the subjects. The subject number determining device searches both eyes of each subject in the still image to detect the faces. The subject number determining device calculates the distance between both eyes as the size of the face.

The display time is calculated by multiplying the number of the subjects by a predetermined coefficient. The coefficient is set smaller when the number of the subjects is larger than a predetermined number as compared to when the number of the subjects is smaller than the predetermined number. A frame of the still image is divided into a center area and a peripheral area to calculate the number of the faces in each of the areas. The display time is set by multiplying the number of the faces in each of the areas by different coefficients. Note that the center area is assigned with the coefficient larger than that assigned for the peripheral area.

The image reproduction apparatus of the present invention operates in a plurality of modes in which a display time setting processes executed by the subject number determining device and the display time setting device differs. The modes are switchable.

A computer executable image reproduction program of the present invention includes the steps of detecting people as subjects in each still image to determine the number of the subjects; and setting display time of each still image based on the determined number of the subjects.

A photo movie producing apparatus of the present invention includes a subject number determining device and a display time setting device. The subject number determining device detects people as subjects in each still image to determine the number of the subjects. The display time setting device sets display time of the photo movie based on the number of the subjects determined by the subject number determining device.

A computer executable photo movie producing program of the present invention includes the steps of detecting people as subjects in each still image to determine the number of the subjects; and setting display time of the photo movie based on the determined number of the subjects.

According to the present invention, the display time for each still image is set based on the number of the subjects in the still image. Therefore, the display time is set short when the number of the subjects is small, whereas it is set long when the number of the subjects is large. Owing to this, it is prevented that a slide show becomes redundant since the display time for the still images having a small number of subjects are not set long. It is also prevented that the still image of many people are switched to another while a viewer is looking at people's faces one by one since the display time for the still images having a large number of subjects are not set short.

According to the present invention, faces of the subjects are detected first, and the number of the subjects is determined based on the number of detected faces. For this configuration, the passing people whose faces are outside the main shooting area, which includes primary subjects, are not calculated as the subjects. Therefore, the number of the primary subjects can be determined accurately.

In addition, the faces smaller in size than the predetermined value are eliminated when the number of the subjects is determined. For this configuration, people who appear small in the background are eliminated. Therefore, the number of the primary subjects can be determined accurately.

Moreover, the faces are detected by searching both eyes of each subject. For this configuration, faces of people can be detected with high accuracy. The distance between both eyes is calculated as the size of the face. Therefore, the number of the primary subjects can be determined more accurately.

The center area is assigned with the coefficient larger than that assigned for the peripheral area. For this configuration, the display time is set long when there are a large number of subjects in the center area, who have high possibility of the primary subjects. Meanwhile, the display time is set short when there a large number of subjects in the peripheral area, who have low possibility of the primary subjects. Therefore, it is possible to set proper display time for any still images captured in various shooting scenes.

The coefficient is set smaller when the number of the subjects is larger than the predetermined number as compared to when the number of the subjects is smaller than the predetermined number. For this configuration, the display time can be set appropriately even for a group shot capturing a large number of people who appear relatively small.

Furthermore, appropriate display time of the photo movie can be automatically set based on the number of the subjects captured in each still image as a material. Therefore, the high quality photo movie, which assures comfortable viewing, can be easily produced, even where quite a number of still images are used.

### BRIEF DESCRIPTION OF THE DRAWINGS

For more complete understanding of the present invention, and the advantage thereof, reference is now made to the following descriptions taken in conjunction with the accompanying drawings, in which:

FIG. 1 is a block schematic diagram of an image reproduction apparatus to which the present invention is applied;

FIG. 2 is a flow chart illustrating a procedure for setting display time;

FIG. 3 is an explanatory view illustrating the distance between both eyes of each subject in a still image being segmented into plural regions;

FIG. 4 is a schematic diagram illustrating a center area and a peripheral area of the still image;

FIG. 5 is a flow chart illustrating an operating procedure of the image reproduction apparatus;

FIG. 6 is a flow chart illustrating an operation of the image reproduction apparatus in accordance with another embodiment of the present invention; and

FIG. 7 is a flow chart illustrating an operation of the image reproduction apparatus in which a user can select to perform either a slide show or a photo movie.

### DESCRIPTION OF THE PREFERRED EMBODIMENTS

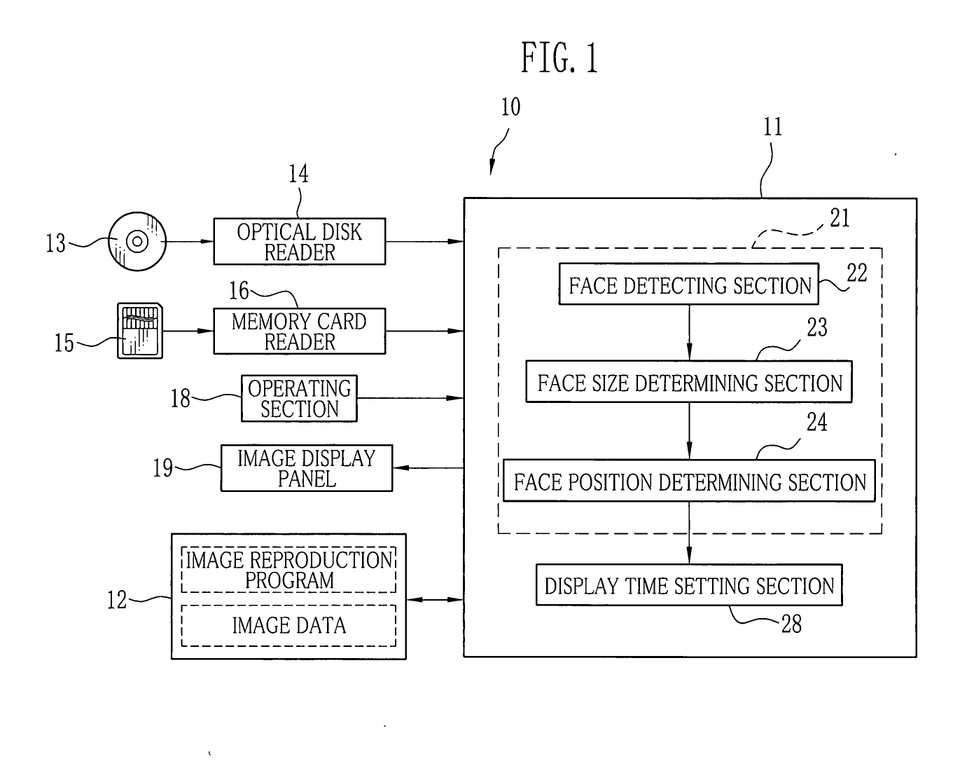

In FIG. 1, an image reproduction apparatus 10 is constituted of a CPU 11, a memory 12, an optical disk reader 15, a memory card reader 16, an operating section 18, an image display panel 19 and the like. The image reproduction apparatus 10 reads out image data of a plurality of still images to reproduce and display them on a screen of the image display panel 19. The image display panel 19 is for example a liquid crystal display panel.

An optical disk 13 and a memory card 15 are removable media, which are removably set to the optical disk reader 14 and the memory card reader 16, respectively. The optical disk reader 14 and the memory card reader 16 respectively detect that the optical disk 13 and the memory card 15 are set, and send a detection signal to the CPU 11.

The CPU 11 controls over the image reproduction apparatus 10 in accordance with operational commands from the operating section 18. The memory 12 stores image reproduction program that is executed by the CPU 11, and image data of the still images read out from the optical disk 13 or the memory card 15.

The image reproduction program is provided for what is called a slide show, in which a plurality of still images is reproduced and displayed in sequence. Upon starting up the image reproduction program, the image display panel 19 displays an image selection screen showing a list of a plurality of the still images stored in the optical disk 13 or the memory card 15. A user selects still images to be reproduced through the operating section 18 with viewing the image selecting screen. When reproduction command is input from the operating section 18, the CPU 11 sends an operation signal for reproducing and displaying the selected still images to the image display panel 19.

Once the image reproduction program is executed, the CPU 11 functions as a processor for executing a plurality of processing steps included in the image reproduction program. The processor includes a subject number determining section 21 and a display time setting section 28. The subject number determining section 21 detects face images by analyzing the image data of each still image, to determine the number of people, which are subjects of the still images (number of the subjects). The display time setting section 28 calculates display time of each still image based on the number of the subjects determined by the subject number determining section 21.

The display time setting section 28 assigns relatively long display time to the still image like a group shot, which has a large number of subjects, whereas it assigns relatively short display time to the still image, which has a small number of subjects.

The still images, however, often contain people who happen to be captured in the background, besides those who are captured as main subjects. There is a worry that the display time may become unnecessarily long when people who are not the main subjects are included in counting the number of the subjects. In view of this, in the image reproduction program, every face image detected in the still image is examined for its size and position in a frame of the still image, and the display time is calculated in consideration of them.

The subject number determining section 21 includes a face detecting section 22, a face size determining section 23 and a face position determining section 24. The face detecting section 22 detects face images of people included in a single still image. The face size determining section 23 determines whether the size of the detected face is larger than a predetermined value. The face position determining section 24 determines whether the position of the detected face within the frame of the still image resides in a predetermined area.

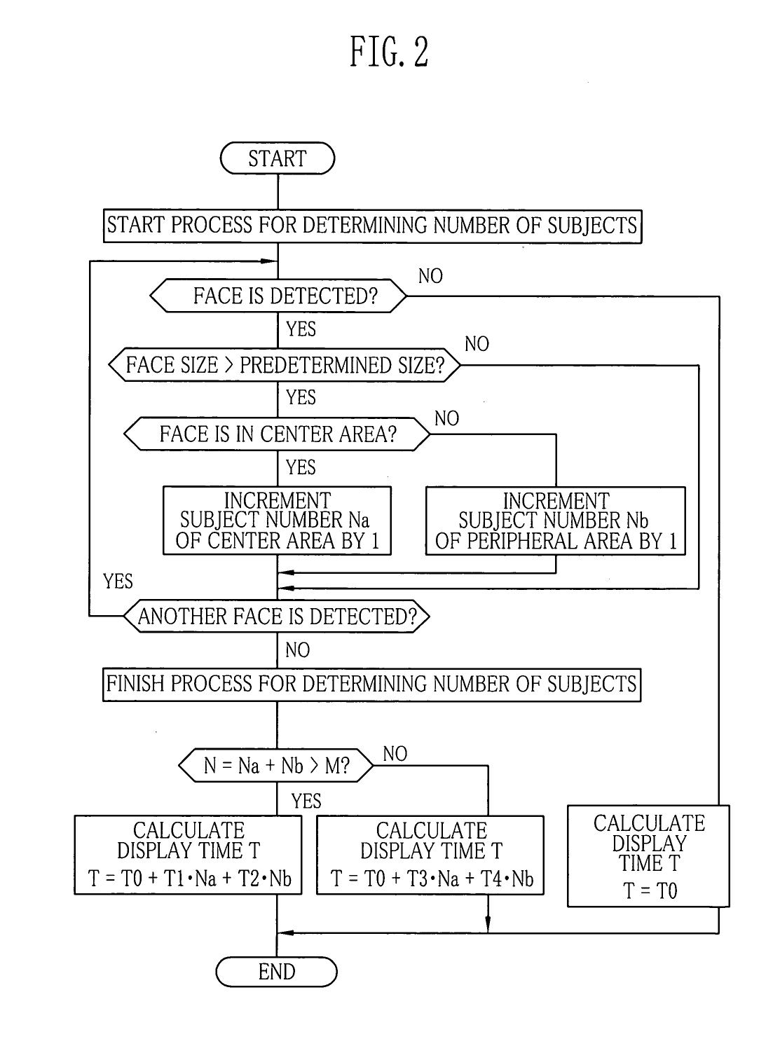

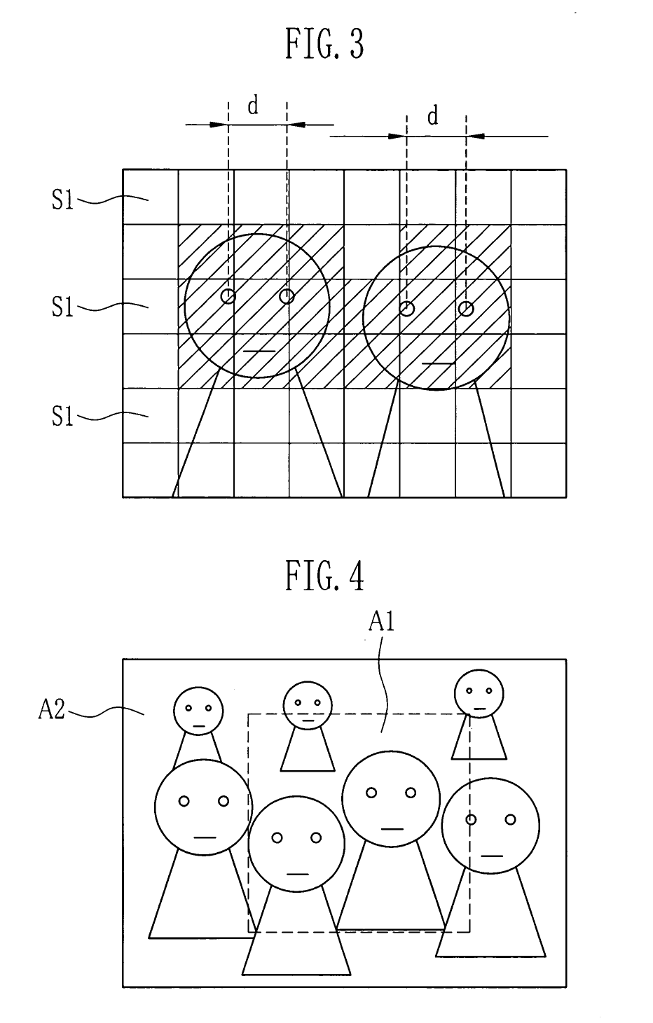

In determining the number of the subjects, at first, the face detecting section 22 detects faces, as shown in a flow chart of FIG. 2. Specifically, the face detecting section 22 segments the frame of a single still image into plural square regions, as shown in FIG. 3. One segmented region is defined as S1. The face detecting section 22 then picks out the segmented regions S1 having relatively many pixels estimated to be of skin color, which are shown by diagonal lines in the drawing. Within the segmented regions S1 with many of the skin color pixels, the face detecting section 22 searches pixels of, for example, iris color and white pixels around the iris color pixels, which correspond to the white parts of an eyeball, thereby one of the eyes is detected. The face detecting section 22 then analyzes the peripheral area around the detected eye to detect the other eye. At the same time, the face detecting section 22 also examines characteristics of other face parts besides the eyes, which are a mouth, nose and the like, to determine a face of a single person. When the face detecting section 22 detects a face, the face detecting section 22 outputs face position information, which shows the position of the face in the frame of the still image, and face size information, which shows the size of the face, as a detection result. Specifically, the face position information is represented by coordinate information of a midpoint of both eyes, and a face coordinate P of the face is output. The face size information is represented by the distance between both eyes, and a distance d between both eyes of the face is output.

The face size determining section 23 compares the distance d with a predetermined criterion value D, and determines whether the distance d is larger than the criterion value D or not. The criterion value D is a threshold value that is set to distinguish between people as the main subjects and people happen to be captured in the background. The criterion value D is set based on a predetermined rate to a resolution of the still image. The value is set greater for high resolution still images, whereas it is set lower for low resolution still images. Owing to the determination of the size of the face, the number of the faces of the people appear in the background is eliminated, and thus a number N of the subjects who are recognized as the main subjects can be narrowed down.

The face position determining section 24 determines whether the face with the distance d determined larger than the criterion value D is in a center area or in a peripheral area in the frame of the still image. Specifically, the face position determining section 24 determines whether the face coordinate P is in a square center area A1, which is set at the center of the still image, or in a peripheral area A2, which is set around the center area A1, as shown in FIG. 4. Note that, the center area A1 is not limited to be of square, but may be of other shapes like rectangle or oval. When the face is in the center area A1, the face position determining section 24 counts the face in a number Na of the subjects in the center area A1. When the face is in the peripheral area A2, the face determining section 24 counts the face in a number Nb of the subjects in the peripheral area A2.

Such process of the face size determination and the face position determination is repeated to the number of faces detected in the single still image. The ultimately calculated subject number N of the subjects (Na+Nb) is output to the display time setting section 28.

The display time setting section 28 calculates display time T of the still image based on the subject number Na of the center area A1 and the subject number Nb of the peripheral area A2. In calculating the display time T, it is determined whether the subject number N is larger than a criterion subject number M. Equations for calculating the display time T differ depending on whether the subject number N is larger or smaller than the criterion subject number M. The criterion subject number M may be, for instance, ten.

When the subject number N is larger than the criterion subject number M, the display time T is obtained as a total sum of a constant T0, a value calculated by multiplying the subject number Na of the center area A1 by a coefficient T1, and a value calculated by multiplying the subject number Nb of the peripheral area A2 by a coefficient T2. That is, the display time T is obtained from an equation: T=T0+T1·Na+T2·Nb in this case. When the subject number N is smaller than the criterion subject number M, the display time T is obtained as a total sum of the constant T0, a value calculated by multiplying the subject number Na of the center area A1 by a coefficient T3, and a value calculated by multiplying the subject number Nb of the peripheral area A2 by a coefficient T4. That is, the display time T is obtained from an equation: T=T0+T3·Na+T4·Nb in this case.

Note that the coefficient T1 is larger than the coefficient T2. Similarly, the coefficient T3 is larger than the coefficient T4. That is, the display time, which is incremented with respect to each subject, is set longer when a large number of subjects exist in the center area A1 as compared to when a large number of subjects exist in the peripheral area A2. Additionally, the coefficient T1 is smaller than the coefficient T3. When the subject number N is larger than the criterion subject number M, the display time, which is incremented with respect to each subject in the center area A1, is set shorter as compared to when the subject number N is smaller than the criterion subject number M. The coefficient T2 is smaller than the coefficient T4. When the subject number N is larger than the criterion subject number M, the display time, which incremented with respect to each subject in the peripheral area A2, is set shorter as compared to when the subject number N is smaller than the criterion subject number M.

By changing the equations according to the subject number N as described above, it is prevented that the display time T is set unduly long. Moreover, since the coefficients are respectively assigned with a weight according to the areas, the display time T is set appropriately. When there is no face detected in the still image, the constant T0 is set as the display time T.

Next, the operation of the image reproduction apparatus 10 is explained. When the optical disk 13 or the memory card 15 is set to the optical disk reader 14 or the memory card reader 16, the CPU 11 starts reading the still images from the medium. The CPU 11 stores the image data of the read still images in the memory 12. The CPU 11 generates thumbnail image data from the read still image data and displays the image selection screen, in which a list of reduced still images is shown, on the image display panel 19. The user operates the operating section 18 to select still images to be in the slide show. Note that the order of displaying the still images can be also changed at this time.

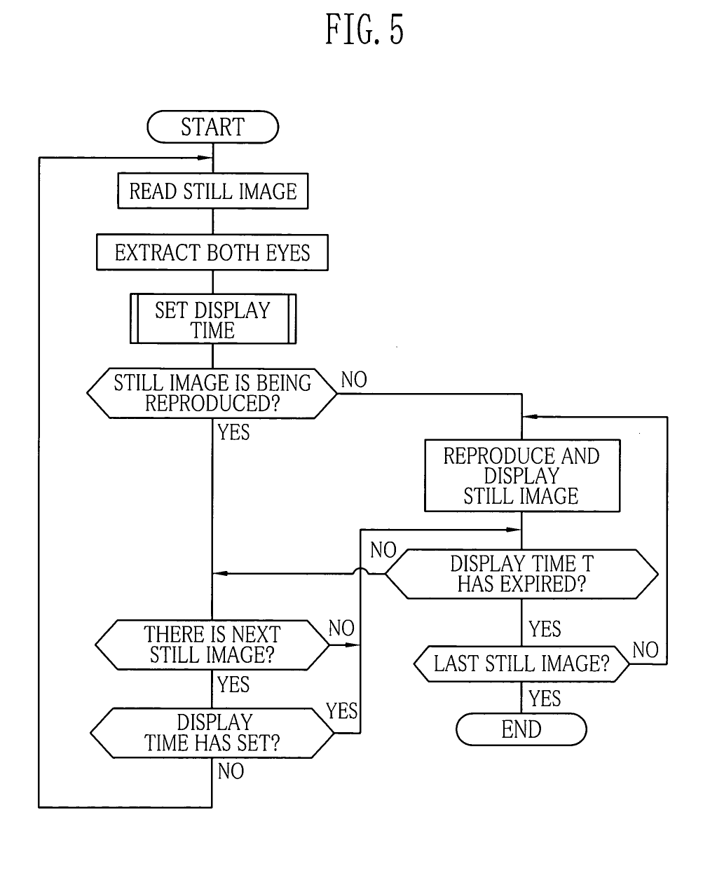

In FIG. 5, the CPU 11 reads the image data of a first still image after the selection of the still images is completed, to execute display time setting processes over the first still image according to the procedure shown in FIG. 2. The subject number determining section 21 detects faces in the still image and executes the face size determination and the face position determination on each detected face. The display time setting section 28 sets the display time of the first still image in accordance with the determination result.

The CPU 11 outputs the image data of this still image into the image display panel 19 to display the still image thereon. The CPU 11 starts measuring the lapse of the display time for the first still image. While the first still image is being reproduced and displayed, the CPU 11 identifies the presence or absence of the still image to be reproduced next. When there is another still image to be reproduced next, the display time for this still image is set. In the same manner as described above, the CPU 11 reads the image data of the second still image from the memory 12 and sets the display time of the second still image.

The CPU 11 starts reproducing and displaying the second still image when the display time of the first still image has expired. When the display time of the second still image is expired, a third still image is reproduced and displayed. In this way, the image display panel 19 shows the slide show of the still images, in which the display time of each still image is appropriately set in accordance with the number of the subjects. For this configuration, the user can take time to view the still images with a large number of subjects. The still images with a small number of subjects is switched relatively short time later, therefore the user can comfortably enjoy the slide show.

In the above embodiment, the image reproduction apparatus 10 calculates the display time of the second still image while displaying the first still image. When high-resolution images are used as the materials, more time will be needed for extracting faces and for specifying the number of the subjects. Thus, it may become difficult to calculate the display time of the second still image while displaying the first still image. Therefore, in using the high-resolution images, it is also possible to set up the image reproduction apparatus 10 to calculate a total display time for all of the still images before starting the display of the still images.

Additionally, in the above embodiment, faces are detected in the still image to execute the face size determination and the face position determination on each detected face, thereby calculating the display time. However, such display time setting processes may be simplified. For instance, either of the face size determination or the face position determination can be omitted, or even both of the determinations can be omitted to calculate the display time. When both of the determinations are omitted, a total number of the detected faces (total detection number X) is directly defined as the subject number N to calculate the display time. By omitting one or both of the display time setting processes, it is possible to shorten the time required before starting displaying still images after the still images are read in.

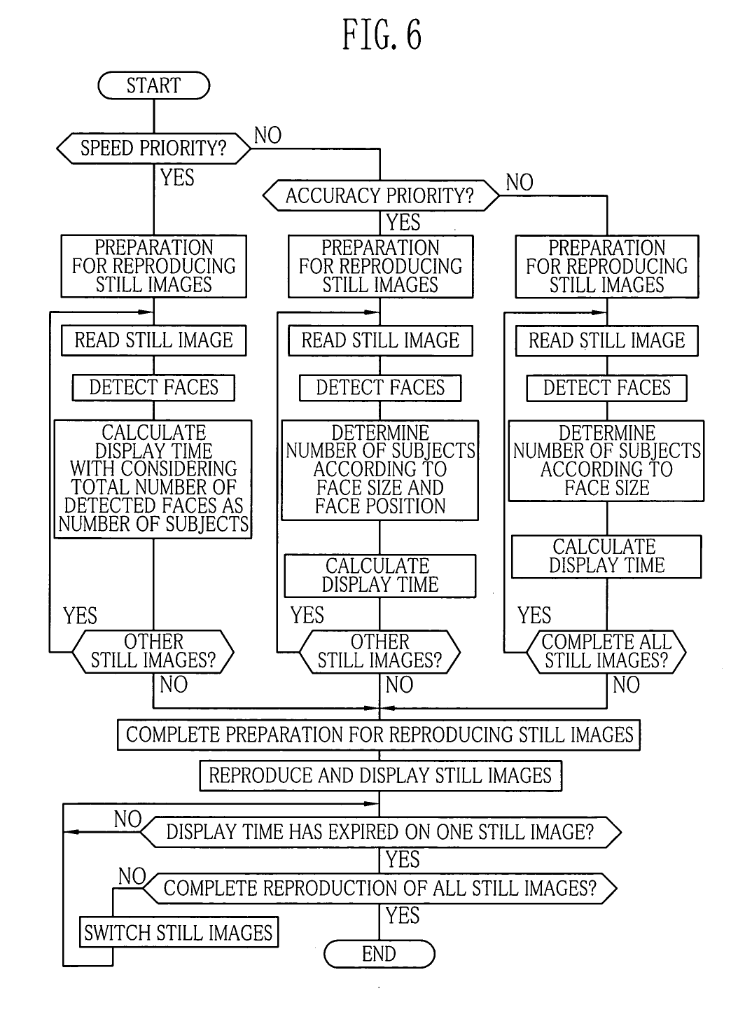

For instance, it is also possible to prepare a plurality of modes in which the display time setting processes differ, as shown in FIG. 6 and allow the user to select one of them. In the example shown in FIG. 6, three kinds of modes: a speed priority mode, a normal mode and an accuracy priority mode, are prepared, and the total display time for all of the still images is calculated before starting a slide show.

The speed priority mode prioritizes shortening the time taken before starting the display of the still images. The speed priority mode calculate the display time with considering the total detection number X as the subject number N without executing both the face size determination and the face position determination. The accuracy priority mode adopts the display time setting processes described in the above embodiment. The accuracy priority mode executes the face size determination and the face position determination on each of the detected faces and calculates the display time. The normal mode executes only the face size determination to narrow down the subjects after extracting faces. The time taken before starting the display of the still images is shortest in the speed priority mode, and is longest in the accuracy priority mode among the three modes. It is preferable to allow the user to select the processes for calculating the display time based on the purpose of the slide show.

In the above embodiment, any face determined to be smaller than the predetermined size in the face size determination is not counted in the subject number N irrespective of which area the face belongs to. However, for instance, it is possible to count all of the faces in the center area A1 in the subject number N regardless of their size.

In the above embodiment, the face size determination is executed based on the predetermined criterion value D. However, it is also possible that the face size determination is executed based on the face having the largest size among the detected faces. In this case, the size of every face is compared to the largest size and those face having the relative difference larger than a predetermined value are not counted in the subject number N.

It is possible that the still images are sorted into the images of people as subjects and the scenic shots so that the slide show is set to consecutively display the images of people first, or is set to consecutively display the scenic shots first.

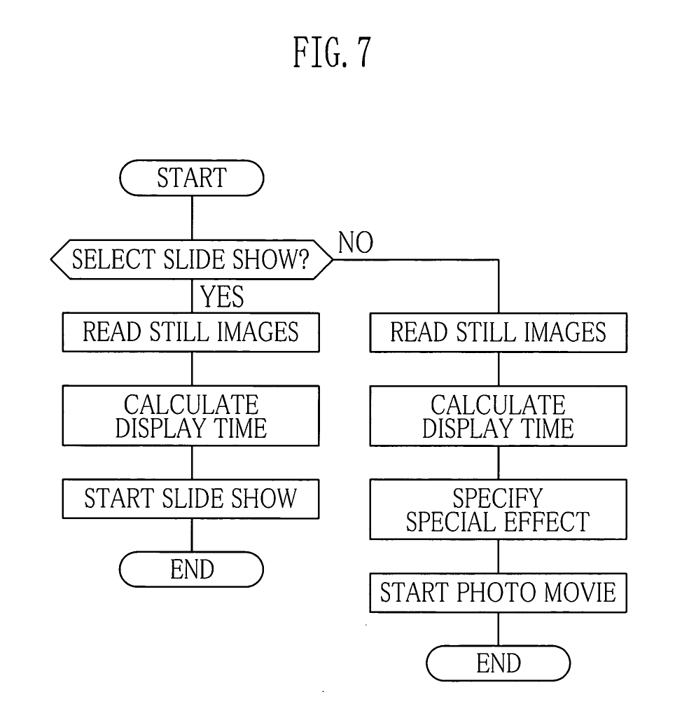

The image reproduction apparatus 10 displays the slide show of the still images, in which the display time for each still image is different depending on its content. It is also possible to incorporate a photo movie producing program with the image reproduction program so that the user can appropriately select either one of the slide show or the photo movie, as shown in FIG. 7.

In the photo movie, special effects are added to the still images by applying predetermined processing thereto, to reproduce the still images as a moving image. The special effects include well known effects, such as a zooming effect for zooming in/out a part of a still image, a panning effect for scrolling a closed-up still image, a dissolve effect in which a still image fades in while another still image being displayed fades out, a wipe effect for wiping across a displayed still image to insert another still image from the edge of the screen, and the like. After the display time is calculated based on the number of the subjects captured in the still image, the special effect to be applied to each still image in the photo movie is selected. The special effect is randomly selected from among the previously prepared special effects.

For example, when the panning effect is applied to the still image with a plurality of people, one scene showing magnified images of respective faces one after the other is created. By combining a plurality of such scenes, one photo movie is created. Note that one scene is created from at least one still image, but may be created by synthesizing a plurality of still images.

The above image reproduction program analyzes the still image to be a material for one scene and determines the number of the subjects in the still image, thereby calculating the display time of the scene. Such process is executed for each scene and the display time for each scene is calculated in this way. For this configuration, the display time for each scene can be set appropriately according to the number of the subjects. Display time of the photo movie is a total display time of all the scenes included therein.

Note that the present invention is not limited to the apparatus for displaying the slide show or the photo movie created from the still images, but also applicable for a digital still camera or image recording apparatuses like a digital video camera, which is capable of capturing still images. The image reproduction program and the photo movie producing program of the present invention may be stored in the recording media so that they can be provided as an application program, which is implemented their function by being installed in a general purpose personal computer.

As described so far, the present invention is not to be limited to the above embodiments, and all matter contained herein is illustrative and does not limit the scope of the present invention. Thus, obvious modifications may be made within the spirit and scope of the appended claims.

What is claimed is:

1. An image reproduction apparatus for reproducing and displaying a plurality of still images on a monitor in sequence, said image reproduction apparatus comprising:
a subject number determining device that detects people as subjects in each still image to determine the number of said subjects; and
a display time setting device for setting display time of each still image based on the number of said subjects determined by said subject number determining device.

2. An image reproduction apparatus claimed in claim 1, wherein said subject number determining device detects faces of said subjects and determines the number of said subjects based on the number of detected faces.

3. An image reproduction apparatus claimed in claim 2, wherein said subject number determining device comprising:
a face size determining device for determining whether each of said faces is larger in size than a predetermined value,
wherein said subject number determining device eliminates said faces smaller in size than said predetermined value to determine the number of said subjects.

4. An image reproduction apparatus claimed in claim 2, wherein said subject number determining device searches both eyes of each of said subjects in said still image to detect said faces.

5. An image reproduction apparatus claimed in claim 2, wherein said subject number determining device calculates the distance between said both eyes as the size of said face.

6. An image reproduction apparatus claimed in claim 2, wherein said display time setting device calculates said display time by multiplying the number of said subjects by a predetermined coefficient.

7. An image reproduction apparatus claimed in claim 6, wherein said coefficient is set smaller when the number of said subjects is larger than a predetermined number as compared to when the number of said subjects is smaller than said predetermined number.

8. An image reproduction apparatus claimed in claim 6, wherein said subject number determining device divides a frame of said still image into a center area and a peripheral area to calculate the number of said faces in each of said areas, whereas said display time setting device sets said display time by multiplying the number of said faces in each of said areas by different coefficients, said center area being assigned with said coefficient larger than that assigned for said peripheral area.

9. An image reproduction apparatus claimed in claim 1, wherein said subject number determining device and said display time setting device are able to operate in a plurality of different modes for different processes of setting said display time, said modes being switchable.

10. A computer executable image reproduction program for reproducing and displaying a plurality of still images on a monitor in sequence, said image reproduction program comprising the steps of:
detecting people as subjects in each still image to determine the number of said subjects; and
setting display time of each still image based on the determined number of said subjects.

11. A photo movie producing apparatus for producing a photo movie from at least one still image with special effects added thereto, said photo movie producing apparatus comprising:
a subject number determining device that detects people as subjects in each still image to determine the number of said subjects; and
a display time setting device for setting display time of said photo movie based on the number of said subjects determined by said subject number determining device.

12. A computer executable photo movie producing program for producing a photo movie from at least one still image with special effects added thereto, said photo movie producing program comprising the steps of:
detecting people as subjects in each still image to determine the number of said subjects; and
setting display time of said photo movie based on the determined number of said subjects.
